(19) United States
(12) Patent Application Publication
(10) Pub. No.: US 2010/0251733 A1
(43) Pub. Date: Oct. 7, 2010

(54) ICE MAKING TECHNOLOGY

(75) Inventors: Seong-Jae KIM, Seoul (KR); Nam-Gi LEE, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/731,677

(22) Filed: Mar. 25, 2010

(30) Foreign Application Priority Data
Apr. 2, 2009 (KR) 10-2009-0028629

(51) Int. Cl. F25C 5/08; F25C 1/00; F25C 5/02; G05D 7/00; F25D 13/04

(52) U.S. Cl. 62/73; 62/347; 62/351; 62/320; 700/282; 62/441

(57) ABSTRACT

An ice making device, a refrigerator having the ice making device, and a method for making ice are disclosed. Water is supplied to an ice making structure of an ice making device and frozen into ice. The ice is at least partially released from the ice making structure by supplying liquid water to the ice making structure to apply force to the ice in the ice making structure.

### CROSS REFERENCE TO RELATED APPLICATIONS

The present application claims priority to Korean Application No. 10-2009-0028629 filed in Korea on Apr. 2, 2009, the entire contents of which is hereby incorporated by reference in its entirety.

### FIELD

The present disclosure relates to ice making technology.

### BACKGROUND

In general, a refrigerator is a device for maintaining food items at a low temperature in a certain accommodating space, including a refrigerating chamber maintained at temperature of above zero and a freezing chamber maintained at temperature of below zero. Refrigerators may include an automatic ice making device.

The automatic ice making device may be installed in the freezing chamber or in the refrigerating chamber. When the ice making device is installed in the refrigerating chamber, cool air from the freezing chamber may be provided to the ice making device to make ice.

An ice release mechanism for the ice making device may include a twisting type ice making device, an ejector type ice making device, and a rotation type ice making device. The twisting type ice making device releases ice by twisting an ice making container, the ejector type ice making device releases ice by allowing an ejector installed at an upper portion of the ice making container to eject ice from the ice making container, and the rotation type ice making device releases ice by rotating the ice making container.

### SUMMARY

In one aspect, an ice making device includes one or more ice making structures that each define an ice making space configured to receive and hold liquid water and a water supply unit connected to the ice making space of at least one of the ice making structures. The water supply unit is configured to supply a first amount of liquid water to the ice making space of the at least one of the ice making structures to which the water supply unit is connected. The first amount of liquid water is received in the ice making space and is frozen into ice. The water supply unit is configured to, subsequent to the first amount of liquid water being received in the ice making space and being frozen into ice, supply a second amount of liquid water to the ice making space of the at least one of the ice making structures to which the water supply unit is connected. The second amount of liquid water is less than the first amount of liquid water and applies force to the ice made in the ice making space to partially release the ice from the ice making space.

Implementations may include one or more of the following features. For example, the ice making device may include a heater configured to apply heat to an inner surface of the at least one of the ice making structures to facilitate release of the ice from the ice making space.

In another aspect, an ice making device includes an ice making structure that defines an ice making space configured to receive and hold liquid water and a water supply unit configured to supply liquid water to the ice making space defined by the ice making structure. The ice making device also includes a control unit configured to control an amount of water supplied to the ice making structure by the water supply unit. The control unit is configured to, in response to user actuation of an ice dispenser, control the water supply unit to supply liquid water to the ice making space of the ice making structure to apply force to ice made in the ice making space and at least partially release the ice from the ice making space.

Implementations may include one or more of the following features. For example, the ice making structure may be an ice making tube that has a length that is larger than a diameter of the ice making tube, has a first end that is open and configured to allow ice to be released from the ice making tube, and has a second end that is hermetically connected with the water supply unit and that is configured to receive liquid water from the water supply unit. The ice making device may include a cutter that is positioned at the first end of the ice making tube and that is configured to cut ice made in the ice making tube into one or more ice pieces when the ice made in the ice making tube is partially released from the ice making space by the supply of liquid water.

In some implementations, the ice making device may include a transfer tube that is configured to guide ice pieces cut by the cutter and that is positioned at the first end of the ice making tube. In these implementations, the cutter may be positioned within the transfer tube. The cutter may be configured to rotate in a direction that is perpendicular to an ice transfer direction of ice pieces being guided in the transfer tube. The cutter may have blades that are screw shaped and that are wound in one or more directions. The ice making device may include multiple ice making tubes, the cutter may include multiple cutters, a first of the multiple cutters may be positioned at a first side of the transfer tube, a second of the multiple cutters may be positioned at a second side of the transfer tube that is opposite of the first side, and at least a portion of ice made by the multiple ice making tubes may be positioned between the first and second cutters.

In addition, the ice making device may include multiple ice making tubes. The multiple ice making tubes may be oriented in parallel in a lengthwise direction, may be connected to a single transfer tube, and a single cutter may be installed within the single transfer tube. A tube cover may be positioned at the first end of the ice making tube and may be configured to open and close the first end of the ice making tube.

In some examples, the ice making device may include a heater configured to apply heat to the ice making structure to facilitate release of the ice from the ice making space. In these examples, the heater may contact the ice making structure. The heater also may be spaced apart from the ice making structure. The heater may include a plurality of heaters that are each independently controlled and that are each positioned at a different portion of the ice making structure.

The plurality of heaters may include a first heater and a second heater and the ice making space of the ice making structure may receive liquid water from the water supply unit at an entry point. The first heater may be positioned at a first portion of the ice making structure and the second heater may be positioned at a second portion of the ice making structure that is further from the entry point than the first portion of the ice making structure. During an ice release operation, the first heater may be controlled to apply heat to the first portion of the ice making structure prior to the second heater being controlled to apply heat to the second portion of the ice making structure. Further, the ice making structure may be an ice making tube that has different diameters along a lengthwise direction and a first diameter of the first portion where the first heater is positioned may be smaller than a second diameter of the second portion where the second heater is positioned.

In addition, the control unit may be configured to control the heater in conjunction with the water supply unit such that the control unit controls the heater to correspond to the supply, by the water supply unit, of liquid water to the ice making space of the ice making structure to apply force to the ice made in the ice making space and at least partially release the ice from the ice making space. The control unit may control the heater based on an amount of water supplied by the water supply unit. The control unit may control the heater according to a change in temperature of the ice making structure.

In some implementations, the ice making device may include a water supply valve configured to control flow of liquid water from the water supply unit to the ice making structure. In these implementations, the control unit may be configured to control the water supply valve based on at least one of a water supply time duration and an amount of water supply.

In yet another aspect, a refrigerator includes a refrigerator body, a refrigerating compartment defined by the refrigerator body, and a freezing compartment defined by the refrigerator body and separated from the refrigerating compartment by one or more walls. The refrigerator also includes an ice making compartment positioned at a refrigerating compartment region of the refrigerator body and configured to receive cool air from the freezing compartment, an ice dispenser configured to dispense ice, and an ice making device. The ice making device includes an ice making structure that defines an ice making space configured to receive and hold liquid water. The ice making structure is positioned in the ice making compartment. The ice making device also includes a water supply unit configured to supply liquid water to the ice making space defined by the ice making structure and a control unit configured to control an amount of water supplied to the ice making structure by the water supply unit. The control unit is configured to, in response to user actuation of the ice dispenser, control the water supply unit to supply liquid water to the ice making space of the ice making structure to apply force to ice made in the ice making space and at least partially release the ice from the ice making space.

Implementations may include one or more of the following features. For example, the refrigerator may include a refrigerator door coupled to the is refrigerator body and configured to open and close at least a portion of the refrigerating compartment. In this example, the ice dispenser may be positioned on an external surface of the refrigerator door and may be configured to dispense ice made by the ice making device through the refrigerator door. The ice making compartment may be positioned on an internal surface of the refrigerator door that is opposite of the external surface and may be positioned such that at least a portion of the ice compartment overlaps with the dispenser.

The ice making structure may include a plurality of ice making tubes arranged in a single row. The ice making structure may include a plurality of ice making tubes arranged in multiple rows.

In another aspect, an ice making method of an ice making device includes supplying a first amount of liquid water to an ice making structure configured to receive and hold liquid water and freezing the first amount of liquid water supplied to the ice making structure into ice stored in the ice making structure. Subsequent to the first amount of liquid water being supplied to the ice making structure and being frozen into ice, the ice stored in the ice making structure is partially released by supplying a second amount of liquid water to the ice making structure to apply force to the ice stored in the ice making structure. The second amount of liquid water is less than the first amount of liquid water.

Implementations may include one or more of the following features. For example, the method may include detecting a value based on at least one of a time period during which water is supplied to the ice making structure and an amount of water supplied to the ice making structure and determining whether or not the detected value has reached a pre-set value. The method also may include detecting a change in temperature of the ice making structure or detecting amount of time lapsed after supplying the first amount of water to the ice making structure and determining whether or not the first amount of liquid water has been frozen into ice based on the detected change in temperature of the ice making structure or the detected amount of time lapsed after supplying the first amount of water to the ice making structure.

In some examples, the method may include, prior to partially releasing the ice stored in the ice making structure by supplying the second amount of liquid water to the ice making structure, applying heat to the ice making structure to facilitate release of the ice from the ice making structure when the second amount of water is supplied. In these examples, the method may include, prior to partially releasing the ice stored in the ice making structure by supplying the second amount of liquid water to the ice making structure, stopping a supply of cool air to the ice making compartment.

### BRIEF DESCRIPTION OF THE DRAWINGS

FIG. 1 is a perspective view of a bottom-freezer type refrigerator having an ice making device;

FIG. 2 is a perspective view showing an ice making device in FIG. 1;

FIG. 3 is a sectional view taken along line I-I in FIG. 2;

FIG. 4 is a sectional view taken along line II-II in FIG. 2;

FIG. 5 is a sectional view taken along line III-III in FIG. 2, showing one example;

FIG. 6 is a sectional view taken along line III-III in FIG. 2, showing another example;

FIG. 7 is a sectional view showing another example of a cutter of the ice making device of FIG. 2;

FIG. 8 is a sectional view showing an example including a tube cutter according to an installation form of an ice making tube in the ice making device of FIG. 2;

FIG. 9 is a vertical sectional view showing an ice making process of the ice making device in FIG. 2;

FIG. 10 is a flow chart illustrating an ice making process in the ice making device in FIG. 2;

FIGS. 11 and 12 are plan view and sectional view showing examples with respect to a disposition structure of a dispenser and the ice making device in FIG. 2;

FIG. 13 is a sectional view showing another example of an ice making device; and

FIG. 14 is a flow chart illustrating an ice making process in the ice making device in FIG. 13.

### DETAILED DESCRIPTION

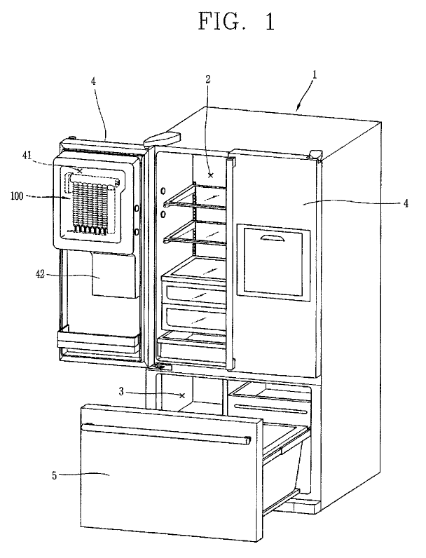

FIG. 1 illustrates an example of a 3-door bottom freezer type refrigerator. As shown in FIG. 1, a refrigerator includes a refrigerating chamber 2 defined at an upper portion of a refrigerator body 1. The refrigerating chamber 2 keeps food items in storage at a refrigerating temperature above freezing. A freezing chamber 3 is defined at a lower portion of the refrigerator body 1. The freezing chamber 3 keeps food items in storage at a freezing temperature at or below freezing.

A plurality of refrigerating chamber doors 4 are installed at both sides of the refrigerating chamber 2 and open and close the refrigerating chamber 2 at both sides. A single freezing chamber door 5 is installed at the freezing chamber 3 to open and close the freezing chamber 3.

A machinery room in which a compressor and a condenser are installed is defined at a lower end of a rear surface of the refrigerator body 1. An evaporator is connected to the condenser and the compressor and supplies cool air to the refrigerating chamber 2 or the freezing chamber 3. The evaporator is generally installed on a rear surface of the refrigerator body 1, for example, between an outer case and an inner case on a rear wall face of the freezing chamber. In other examples, the evaporator may be installed within a side wall face or an upper side wall face of the freezing chamber, or installed within a barrier dividing the refrigerating chamber 2 and the freezing chamber 3. A single evaporator may be installed to supply cool air to the refrigerating chamber 2 and the freezing chamber 3, or a refrigerating chamber evaporator and a freezing chamber evaporator may be provided to independently supply cool air to the refrigerating chamber 2 and the freezing chamber 3, respectively.

An ice making chamber 41 is positioned at an inner wall face of an upper portion of one of the refrigerating chamber doors 4, and an ice making device 100 is installed at an inner side of the ice making chamber 41 to make ice. A dispenser 42 is installed at a lower side of the ice making chamber 41 to allow ice made in the ice making device 100 to be dispensed from to an exterior of the refrigerator.

When a load in the refrigerating chamber 2 or in the freezing chamber 3 is detected, the compressor operates to generate cool air in the evaporator, and one portion of the cool air is supplied to the refrigerating chamber 2 and the freezing chamber 3 and another portion of the cool air is supplied to the ice making chamber 41. The cool air supplied to the ice making chamber 41 is heat-exchanged to allow the ice making device 100 mounted in the ice making chamber 41 to make ice. The cool air supplied to the ice making chamber 41 is returned to the freezing chamber 3 or supplied to the refrigerating chamber 2. The ice made by the ice making device 100 is dispensed according to a request from the dispenser 42. This process is repeatedly performed.

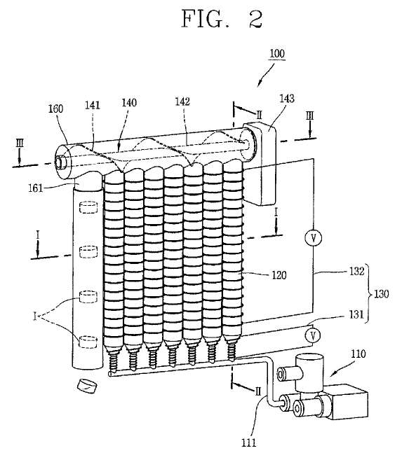

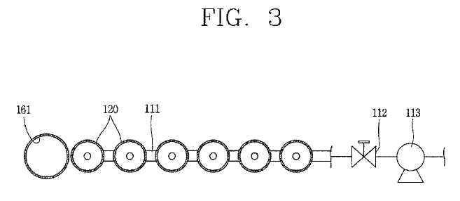

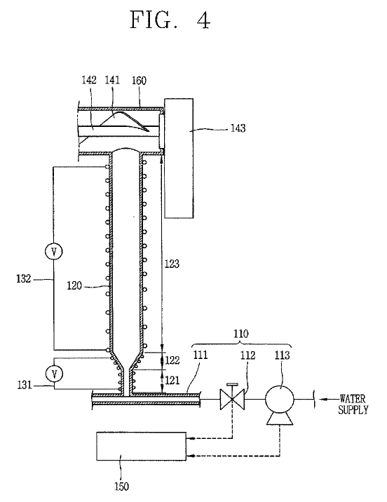

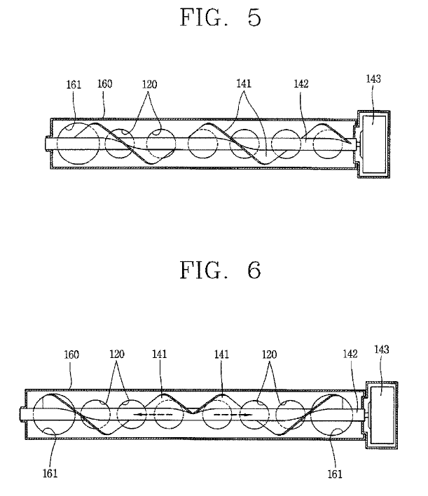

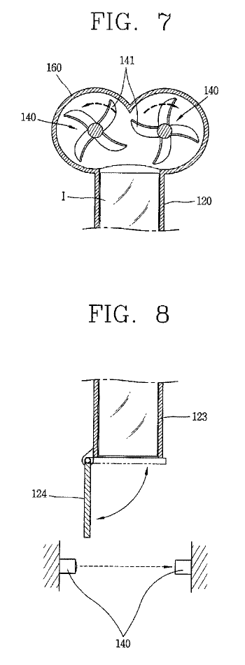

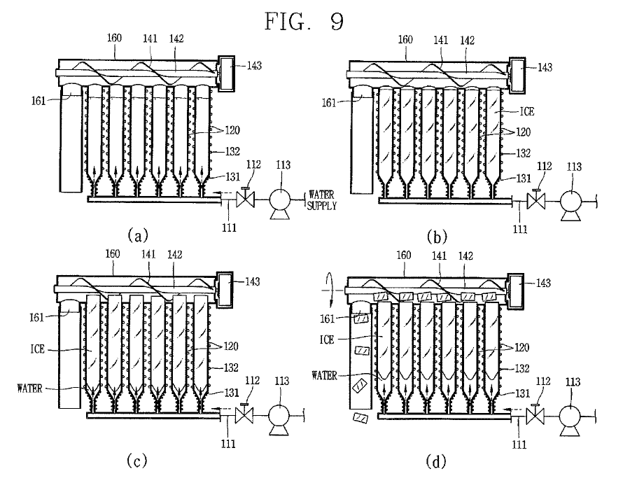

FIG. 2 illustrates an example of an ice making device shown in FIG. 1, FIG. 3 illustrates the example of the ice making device taken along line I-I in FIG. 2, FIG. 4 the example of the ice making device taken along line II-II in FIG. 2, FIG. 5 illustrates a first example of the ice making device taken along line in FIG. 2, FIG. 6 illustrates a second example of the ice making device taken along line in FIG. 2. FIG. 7 illustrates an example of a cutter of the ice making device of FIG. 2, and FIG. 8 shows an example including a tube cutter according to an installation form of an ice making tube in the ice making device of FIG. 2.

As shown in FIG. 2, the ice making device 100 includes a water supply unit 110 connected to a water supply source to supply water, one or more ice making tubes 120 for making ice upon receiving water supplied from the water supply unit 110, a heater 130 installed on an outer circumferential surface of the ice making tubes 120 and configured to apply heat to the ice making tubes 120 to separate ice from the ice making tubes 120, and a cutter 140 installed at an opening end of the ice making tubes 120 and configured to cut ice (I) released from the ice making tubes 120 into a proper size.

As shown in FIGS. 2 to 4, the water supply unit 110 includes a water supply pipe 111 for connecting the water supply source and the ice making tubes 120, a water supply valve 112 installed at a middle portion of the water supply pipe 111 to control the amount of water supply, and a water supply pump 113 installed at an upper flow portion or lower flow portion of the water supply valve 112 and configured to pump water. The water supply pump 113 provides a uniform water pressure, but is not required. If the water supply pump 113 is excluded, water may be supplied by using a height difference between the water supply source and the ice making tube 120.

The water supply pipe 111 may be independently connected according to the number of ice making tubes 120. When a plurality of ice making tubes 120 are provided, the water supply pipe 111 may be connected in parallel to the plurality of ice making tubes 120. This arrangement may result in an easier controlling operation and lower fabrication costs.

The water supply pipe 111 may be directly connected to the water supply source to supply water, and also may be connected to a water tank (not shown) provided in the refrigerating chamber and storing a certain amount of water. In this case, the water tank serves as a water supply source. Here, in order to supply a proper amount of water to the ice making tubes 120, a water level sensor may be installed at the ice making tubes 120, a flux sensor for detecting a flow amount of water may be installed at the water supply pipe, and/or a water level sensor may be installed at the water tank.

The water supply valve 112 and the water supply pump 113 may be electrically connected to transmit and receive a signal to and from a separately provided control unit 150. The control unit 150 may adjust the amount of water supply based on a value detected by the water level sensor or the flow amount sensor in real time, or an operation of the water supply valve 112 and the water supply pump 113 may be made daily and periodically turned on or off.

As shown in FIGS. 2 to 4, a single ice making tube may be provided according to the capacity of the refrigerator or an ice making capacity, but preferably, a plurality of ice making tubes 120 are provided to reduce the diameter of each ice making tube. The ice making tubes 120 may be arranged in a row or may be arranged in double rows in consideration of their relationship with peripheral components. For example, in order to minimize a forward/backward width taken up by the ice making tubes 120, the ice making tubes 120 may be arranged in a row on the same plane as shown in FIG. 3, and in order to minimize a left/right width taken up by the ice making tubes 120, the ice making tubes 120 may be arranged in double rows. In order to minimize both the forward/backward width and the left/right width, the ice making tubes 120 may be arranged in zigzags. Any arrangement of the ice making tubes 120 may be used and the arrangement of the ice making tubes 120 may be properly adjusted as necessary.

The ice making tubes 120 are made of a heat-conductive material such as aluminum and may have various sectional shapes such as a circular section or an angular sectional shape with a certain thickness. The ice making tubes 120 may have the same sectional area and shape in a lengthwise direction or may have a different sectional area and shape along the lengthwise direction as necessary. If the ice making tubes 120 have a different sectional area and shape in the lengthwise direction, the ice making tubes 120 may have a shape such that their width increases toward the opening end (e.g., an ice separating end) to allow ice made in the ice making tubes 120 to be more easily separated along the lengthwise direction.

For example, as shown in FIG. 4, the opening end of the ice making tubes 120 may have a long funnel-like shape. To this end, the ice making tube 120 includes a water supply part 121 with a relatively small diameter connected to the water supply pipe 111, a pressing part 122 extending in a conic sectional shape from an end of the water supply part 121, and an ice making part 123 with a relatively large diameter positioned at the end of the pressing part 122 and configured to make ice. In order to allow ice of the water supply part 121 to quickly melt or in order to supply a uniform water pressure to ice of the ice making unit 123, the water supply part 121 may be smaller than the diameter of the ice making part 123. The end of the ice making part 123 may be open and vertically oriented to define an upper end, and properly arranged as necessary as described above.

As shown in FIG. 4, the heater 130 may include a heating wire wound in contact with an outer circumferential surface of the ice making tube 120. In this case, the heater 130 may constitute a single circuit according to the shape of the ice making tube 120. Or, as shown in FIG. 4, when the ice making tube 120 has different sectional areas in the lengthwise direction, the heater 130 may include a plurality of circuits to separate ice in a stepwise manner. For example, the water supply part 121 and the pressing part 122 of the ice making tube 120 may be installed such that the first heater 131 starts to operate at an early stage of ice separation and comes in contact with the water supply part 121 and the pressing part 122. The ice making part 123 of the ice making tube 120 may include a second heater 132 that operates at a latter (e.g., last) stage of the ice separation and operates after the first heater 131.

The heater 130 may be controlled to work together with the water supply unit 110. For example, it is determined whether or not water is supplied to the ice making tube 120 for making ice, whether or not ice making is currently performed, or whether or not ice separation is performed after ice making is completed based on a change in the value detected by the water level sensor or the flux sensor of the water supply unit 110. If it is determined that water is supplied for making ice or if it is determined that ice making is performed upon completion of water supply, the operation of the heater is controlled to be stopped. If it is determined that ice separation is performed after completion of ice making, the operation of the heater 130 may be controlled to start.

A time point when the heater 130 starts to operate may be determined by detecting the temperature of the ice making tube 120 in real time or periodically, or a duration of time which has passed after the water level sensor or the flux sensor of the water supply unit 110 was changed and the heater 130 may be operated according to the data value of the water level sensor or the flux sensor of the water supply unit 110. For instance, whether or not the operation of ice separation may be checked by detecting the temperature of the ice making tube 120 or through an ice making time duration. For example, if the temperature measured by the temperature sensor mounted at the ice making tube 120 is lower than a predetermined temperature (e.g., if the temperature measured by the temperature sensor is −9° C. or lower), it may be determined that ice making has been completed. In other examples, when a certain time lapses after a water supply, it may be determined that ice making has been completed.

In addition to the heating wire, the heater 130 may be implemented as a conductive polymer, a plate heater with a positive thermal coefficient, an aluminum thin film, and/or other heat transmission-available materials.

The heater 130 may be attached to the outer circumferential surface of the ice making tube 120. In some implementations, the heater 130 may be positioned within the ice making tube 120 or provided on an inner circumferential surface of the ice making tube 120. Also, the ice making tube 120 may be formed as a resistor that can generate heat, such that at least a portion of the ice making tube 120 may generate heat when electricity is applied thereto, to serve as a heater.

The heater 130 may be configured as a heat source such that it is spaced apart from the ice making tube 120, rather than being in contact with the ice making tube 120. Another example of the heat source may be a light source that irradiates light to at least one of ice and the ice making tube 120 or a magnetron that irradiates microwaves to at least one of ice and the ice making tube 120. The heat sources such as the heater, light source or magnetron directly apply thermal energy to at least one of ice and the ice making tube 120 or to the boundary therebetween to melt a portion of the interface of the ice and the ice making tube 120. Accordingly, when water of high pressures is supplied to the ice making tube 120 by the water supply unit 110, although the interface between ice and ice making tube 120 is not thawed, the ice can be separated from the ice making tube 120 by the water pressure. In this case, it may not be easy for the heater 130 to sequentially apply heat according to each portion of the ice making tube 120, and if a plurality of ice making tubes 120 are provided, the heater 130 may not be attached to each of the ice making tubes 120, but the single first heater 131 and the single second heater 132 may be provided to the ice making chamber 41, thereby facilitating installation of the heater 130 and reducing the fabrication cost.

As shown in FIGS. 2 and 5, the cutter 140 is installed at the opening end of the ice making tube 120, for example, at the end of the ice making part 123. The cutter 140 may have any shape so long as it can cut ice into a certain size. For instance, as shown in FIG. 2, the cutter 140 may have a screw shape with blades 141 wound in one direction and a cutter shaft 142 may be installed to be perpendicular to the ice making tube 120 such that rotation of the cutter shaft 142 turns the blades 141 in a direction that enables ice to be cut and separated from the ice making tube 120.

When the blades 141 of the cutter 140 have a screw shape, the blades 141 push up the ice (I) as they rotate, so the shape of the ice making tube 120 or the ice discharging direction corresponds to the direction of force applied to the ice by the blades 141. Also, when the blades 141 of the cutter 140 have a screw shape, the position of an ice discharge hole 161 of a transfer tube 160 may vary according to the screw direction of the blades 141. For instance, as shown in FIG. 5, when the screw of the blades 141 is uni-directional, the ice discharge hole 161 is positioned at one end of the blades 141. In another example, as shown in FIG. 6, when the screw of the blades 141 is bi-directional, the ice discharge hole 161 is positioned at both ends or at a middle portion of the blades 141.

The cutter 140 may be installed within the transfer tube 160 provided at the end of the ice making tube 120. The transfer tube 160 may communicate with the ends of one or more of the plurality of ice making tubes 120. For instance, transfer tube 160 may communicate with the ends of one or more of the plurality of ice making tubes 120 in a direction perpendicular to the ice separation from the opening end of the ice making part 123. The transfer tube 160 has a diameter that is at least as large as an outer diameter of the cutter 140 or an inner diameter of the ice making tube 120. As described above, one or more ice discharge holes 161 may defined at one end or both ends of the transfer tube 160 according to the shape of the cutter 140.

As shown in FIG. 7, the blades 141 of the cutter 140 may rotate in opposite directions from both sides with the separated ice positioned therebetween. In this case, the blades 141 of the cutters 140 may have a screw shape.

A tube cover 124 may be positioned at the opening end of the ice making tube 120 according to an arrangement of the ice making tube 120. For example, as shown in FIG. 8, when the opening end of the ice making tube 120 is arranged toward the ground, the opening end of the ice making tube 120 is closed to store water or block ice separated from the ice making tube 120 from being released. To this end, when the opening end of the ice making tube 120 points to the ground vertically or at an angle, the tube cover 124 may be coupled to the opening end of the ice making tube 120 by a hinge that enables rotation of the tube cover 124. In this case, the cutter 160 may be separated by a distance of rotation of the ice making cover 124 from the ice making tube 120.

Reference numeral 143 denotes a cutter motor. The cutter motor 143 applies force to the cutter shaft 142 to cause the cutter shaft 142 to rotate.

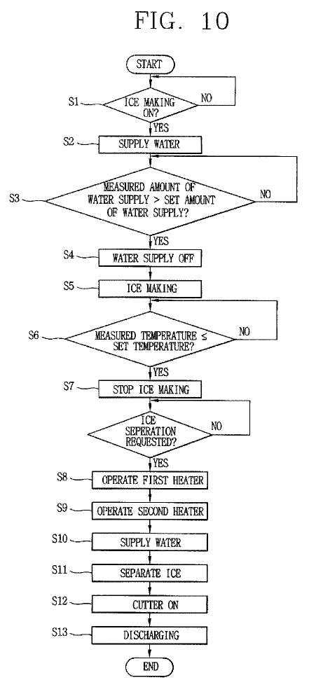

FIGS. 9 and 10 illustrate an example of a process using the ice making device. As shown in FIGS. 9 and 10, when ice making is requested, the ice making device 100 is turned on to perform an ice making operation (S1). When an operation for making ice starts, the water supply unit 110 supplies water to the ice making tube 120 (S2). Diagram (a) in FIG. 9 illustrates a state of water supply to the ice making tube 120.

During water supply, the amount of water supply is detected in real time by using the water level sensor installed at the ice making tube 120, the flux sensor installed at the water supply pipe, or a water level sensor installed at the water tank, or another technique. The detected amount of water supply is sent to a microcomputer (e.g., a processor, a controller, a part of the control unit 150, etc.) and the microcomputer compares the received amount of water supply to a pre-set amount of water supply (S3). Upon comparison, the microcomputer determines whether or not a proper amount of water has been supplied to the ice making tube 120. If it is determined that a proper amount of water has been supplied to the ice making tube 120, the water supply valve of the water supply unit 110 is closed to avoid providing any additional water (S4).

Next, when water supply to the ice making tube 120 is completed, water within the ice making tube 120 is exposed to cool air supplied to the ice making chamber 41 for more than a certain time so as to be frozen (S5). While the water in the ice making tube 120 is being frozen, a temperature sensor detects the temperature of the ice making tube 120 or the transfer tube periodically or in real time and transfers the same to the microcomputer. Upon receiving the measurement temperature, the microcomputer compares it to a pre-set temperature (S6). The microcomputer determines whether or not the surface of water in the ice making tube 120 is frozen based upon the comparison. If it is determined that the surface of water in the ice making tube 120 is frozen, the temperature measurement operation is stopped and the process is changed to an ice separation process (S7). Diagram (b) in FIG. 9 illustrates a state of water supplied to the ice making tube 120 being frozen.

When ice separation is performed, the first heater 131 is operated by the control unit 150, and when the first heater 131 is operated, heat is first applied to the water supply part 121 and the pressing part 122 of the ice making tube 120 to first melt ice of the water supply part 121 and the pressing part 122 (S8). The second heater operates with a certain time difference from the first heater 131 to melt the surface of ice of the ice making part 123 (S9). At this time, the water supply valve 112 is open and the water supply pump 123 operates to supply water from the water supply source toward the ice making tube under the control of control unit 150 (S10).

When ice of the water supply part 121 and the pressing part 122 is melted, water supplied through the water supply pipe 111 is filled in the water supply part 121 and the pressing part 122 to generate a certain water pressure. At the same time, the surface of ice of the ice making part 123 is melted and, thereby, separated by a certain interval from the inner circumferential surface of the ice making part 123. Water supplied through the water supply pipe 111 pushes ice of the ice making part 123 to separate it from the ice making tube 120 (S11). Diagram (c) in FIG. 9 illustrates a state of ice in ice making tube 120 being separated.

Next, the cutter 140 starts to operate when the second heater 132 operates, or with a certain time difference from the point when the second heater 132 operates (S12). Ice of the ice making part 123 is pushed up from the ice making part 123 and then cut by the cutter 140 into a certain size. The cut ice pieces are moved along the transfer tube 160 by the blades 141 of the cutter 140 and then discharged toward the dispenser 42 via the ice discharge hole 161, or discharged to an ice storage container if any (S13). An additional cutter may be provided to further cut discharged ice and produce crushed or shaved ice. Diagram (d) in FIG. 9 illustrates a state of ice separated from the ice making tube 120 being cut and moved to the ice discharge hole 161.

In the process of separating ice or in the process of preparing ice separation in the ice making tube 120, supply of cool air to the ice making chamber 41 may be stopped to facilitate the operation of ice separation and reduce power applied to the heater 130.

When ice discharging is completed, the operations of the heater 130 and the cutter 140 are stopped and the water supply valve 112 is open to supply a proper amount of water to the ice making tube 120 by the water level sensor, the flux sensor, or the like. The process shown in FIG. 10 is sequentially performed.

In some implementations, the amount of water supplied in an ice separation operation is selected to press (e.g., raise or elevate) ice stored in the ice making tubes 120 a particular distance out of the ice making tubes 120. The particular distance may be selected as the size of a preferred ice piece. For example, a user may provide user input indicating a desired ice piece size prior to a dispensing operation (e.g., small, medium, large; or cubed, crushed, shaved; etc.). In this example, the amount of water supplied in the ice separation operation may be tailored to the desired ice piece size selected by the user (e.g., a relatively small amount of water is supplied if the user desires relatively small ice pieces and a relatively large amount of water is supplied if the user desires relatively large ice pieces).

In some examples, when an amount of ice requested in a dispensing operation requires multiple ice separation operations, the water supply valve 112 is controlled to provide repeated bursts or pulses of water. The repeated bursts or pulses may be timed to correspond to a rate of rotation of the cutter such that, when ice is pressed out of the ice making tubes 120, the pressed ice is in position to be cut by the cutter and does not strike a blade of the cutter as the blade passes over an opening of the ice making tubes 120. In other examples, when an amount of ice requested in a dispensing operation requires multiple ice separation operations, the water supply valve 112 is controlled to provide a steady flow of water at a rate in which ice pressed out of the ice making tubes 120 is in position to be cut by the cutter each time the cutter rotates. The rate of water flow may be selected based on rotation speed of the cutter to reduce chances of over pressing or under pressing the ice from the ice making tubes 120.

In some implementations, the size of the ice making device can be reduced, and because the area taken by the ice making device is reduced, the refrigerator having the ice making device can be manufactured to be thinner. For instance, in the related art, the ice making container is wide and the ice separation unit for separating ice from the ice making container is also wide. This widens the ice making device overall and presents complications in making the refrigerator including the ice making device thinner. In some examples, because the ice making device has an ice making tube with a relatively small diameter, the area taken up by the ice making device can be reduced overall.

In addition, the supply path of cool air can be shortened by lowering the installation height of the ice making device. This may reduce a loss of cool air in the process of being supplied to the ice making chamber. For example, in the related art, the ice storage container stores ice made in the ice making container, but in at least some of the implementations described throughout this disclosure, because a long ice making tube is applied, the ice making tube can keep a certain amount of ice in storage, removing the necessity of an ice storage container, and accordingly, the height of the ice making device may be lowered overall, narrowing the distance between the freezing chamber and the ice making chamber. Thus, in some implementations, the cool air supply path can be shortened to reduce a loss of cool air and an input loss for driving the ice making device can be reduced.

In addition, the configuration and control operation of the ice making device can be simplified to reduce the fabrication cost, and a defect caused by malfunction can be reduced in advance. For instance, in the related art, a twisting method, heating method, rotating method, or the like, is used to separate frozen ice. Compared to these methods, in some of the implementations described throughout this disclosure, ice is separated by using the water supply unit that supplies ice making water. Thus, the configuration and operation controlling of the ice making device can be simplified to reduce the fabrication cost of the ice making device overall, and defective ice making caused by malfunction can be prevented in advance to enhance reliability of the ice making device.

In some examples, in the case where the ice making chamber is provided in the refrigerating chamber and the ice making device is operated by guiding cool air from the freezing chamber to the ice making chamber, like the 3-door bottom freezer type refrigerator, the space taken up by the ice making device can be reduced as described above to make the refrigerator thinner. Thus, when the forward/backward directional length of the refrigerator is reduced in harmony with other structures, such as a built-in refrigerator, the ice making device may be applied to reduce the thickness of the refrigerating chamber door to thus enhance the degree of freedom of installation of the refrigerator.

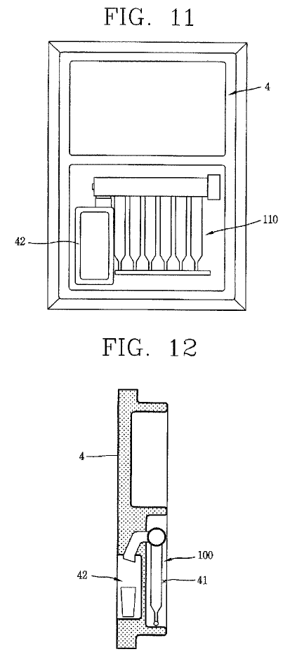

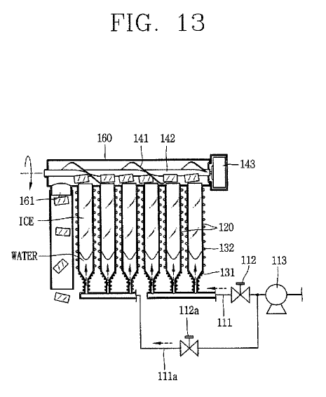

In addition, in some implementations, when the ice making device is used, the transfer tube 160 may be installed at the upper end of the ice making tube 120 to discharge ice from the upper side of the ice making device. Thus, as shown in FIG. 11, the ice making device 100 can be disposed side by side in the horizontal direction at the substantially same height as the lower portion of the refrigerating chamber door or the dispenser. As shown in FIG. 12, the ice making device 100 and the dispenser 42 can be disposed in a forward/backward direction. Thus, the length of the flow path between the freezing chamber 3 and the ice making chamber 41 can be reduced, and accordingly, a loss of cool air that may be generated in the process of supplying cool air to the ice making chamber 41 from the freezing chamber 3 can be reduced to reduce power consumption of the refrigerator. Also, an effective volume of the refrigerating chamber door can be increased.

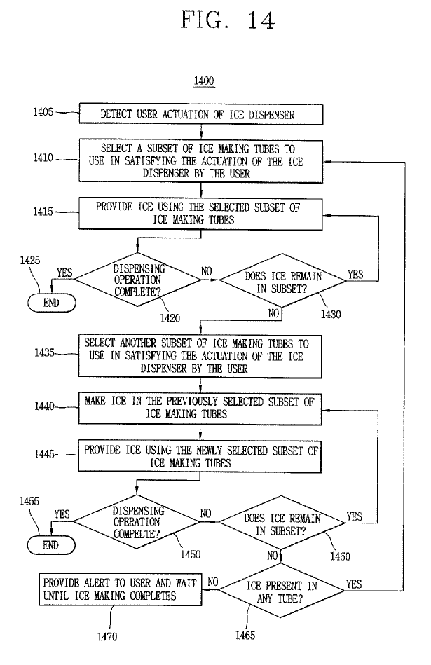

FIG. 13 illustrates another example of an ice making device. The ice making device shown in FIG. 13 is similar to ice making devices described throughout, except that the ice making device has multiple valves that enable separate control of water supply to subsets of the ice making tubes 120.

For example, as shown, the ice making device includes an additional water supply valve 112a and an additional water supply pipe 111a. The additional water supply valve 112a and the additional water supply pipe 111a control supply of liquid water to a first subset of the ice making tubes 120. The first subset of the ice making tubes 120 is different than a second subset of the ice making tubes 120 for which water supply is controlled by the water supply valve 112 and the water supply pipe 111.

Based on this configuration, a control unit may selectively control which of the ice making tubes 120 is used to perform ice making and dispensing operations. In the example shown in FIG. 13, the control unit is controlling the first subset of the ice making tubes 120 to release ice by opening the additional water supply valve 112a and controlling the second subset of the ice making tubes 120 to maintain ice by closing the water supply valve 112. In this example, the ice is maintained in the second subset of the ice making tubes 120 for later use, while the ice in the first subset of the ice making tubes 120 is released and dispensed to satisfy a user's ice dispense command. This type of control may be beneficial for satisfying an ice dispensing operation of long duration or many small ice dispensing operations that are occurring frequently.

For instance, in a situation where many small ice dispensing operations are occurring frequently, the control unit may use the first subset of the ice making tubes 120 to satisfy the ice dispensing operations until the ice in the first subset of the ice making tubes 120 runs out. When the ice in the first subset of the ice making tubes 120 runs out, the control unit switches to the second subset of the ice making tubes 120 to satisfy the ice dispensing operations. While the second subset of the ice making tubes 120 is being used to satisfy the ice dispensing operations, the control unit controls the first subset of the ice making tubes 120 to make ice. By alternating between the first and second subsets, the delay caused by ice running out of the ice making tubes may be reduced and more continuous service may be provided to users.

In some implementations, the control unit controls which of the ice making tubes 120 to use in an ice dispensing operation based on an ice dispensing amount and/or ice dispensing speed desired by the user. For instance, when a relatively small amount of ice is desired and/or a relatively slow ice dispensing speed is desired, the control unit may use a single subset of the ice making tubes. Alternatively, when a relatively large amount of ice is desired and/or a relatively fast ice dispensing speed is desired, the control unit may use both subsets (i.e., all) of the ice making tubes.

In some examples, multiple water supply pumps may be used to separately supply liquid water to subsets of ice making tubes. In addition, although FIG. 13 illustrates two water supply valves, more water supply valves may be used to define smaller subsets of ice making tubes and provide the control unit with finer control over which of the ice making tubes to use in satisfying ice making and ice dispensing operations. For instance, a water supply valve may be provided for each ice making tube such that each ice making tube may be controlled individually.

FIG. 14 illustrates an example ice making process 1400. The example ice making process 1400 may be performed by a control unit (e.g., processor, computer, etc.) of the ice making device shown in FIG. 13. The control unit detects user actuation of an ice dispenser (1405). For example, the control unit may detect a user pressing and holding a dispensing lever with a container. The control unit also may detect a user entering a quantity of ice the user desires and pressing an input button to cause the selected quantity of ice to be dispensed.

The control unit selects a subset of ice making tubes to use in satisfying the actuation of the ice dispenser by the user (1410). In some examples, the control unit determines which of the ice making tubes have frozen ice, rather than unfrozen water. In these examples, the control unit selects the subset of ice making tubes from among the determined ice making tubes having frozen ice.

In some implementations, the control unit selects the subset of ice making tubes based on past usage history. In these implementations, the control unit tracks which ice making tubes have been used in dispensing operations and selects the subset of ice making tubes based on the tracked data. For example, the control unit may select the subset based on how recently the ice making tubes were used to satisfy an ice dispensing operation. In this example, the control unit may avoid ice making tubes used relatively recently (e.g., avoid the most recently used tube) and select ice making tubes that have not been used for a relatively long time (e.g., select the least recently used tube). Selecting the subset of ice making tubes based on how recently the ice making tubes were used to satisfy an ice dispensing operation may distribute wear across all ice making tubes and, thereby, may extend the operating life of the ice making device and reduce the possibility of a frequently used ice making tube being overused. In addition, selecting the subset of ice making tubes based on how recently the ice making tubes were used to satisfy an ice dispensing operation may reduce the possibility of ice becoming stale/old in an ice making tube that is not used frequently.

In some examples, the control unit selects the subset of ice making tubes based on an amount of ice desired and/or an ice dispensing speed desired. For instance, when a relatively small amount of ice is desired and/or a relatively slow ice dispensing speed is desired, the control unit may include a relatively small number of the ice making tubes in the subset. Alternatively, when a relatively large amount of ice is desired and/or a relatively fast ice dispensing speed is desired, the control unit may include a relatively large number of the ice making tubes in the subset.

The control unit provides ice using the selected subset of ice making tubes (1415). For instance, the control unit closes water supply valves of ice making tubes that have not been selected and controls water supply valves of the selected subset of ice making tubes to perform one or more ice separation operations. Providing ice using the selected subset of ice making tubes may use techniques similar to those discussed above with respect to the process described in FIG. 10.

The control unit determines whether the dispensing operation is complete (1420). For example, the control unit determines whether a user is providing input to continue ice dispensing (e.g., continuing to hold a container against an ice dispensing lever or continuing to press an ice dispensing button). When the user has entered a desired quantity of ice to dispense, the control unit determines whether or not the desired quantity of ice has been dispensed.

In response to a determination that the dispensing operation is complete, the control unit ends the dispensing operation (1425). For example, the control unit closes water supply valves for the ice making tubes and controls components of the ice making device to freeze liquid water remaining in the ice making tubes (e.g., the liquid water used to partially release ice from the ice making tubes during the dispensing operation) into ice.

In response to a determination that the dispensing operation is not complete (e.g., ice dispensing continues), the control unit determines whether ice remains in the selected subset of ice making tubes (1430). For example, the control unit may determine whether ice remains in the selected subset of ice making tubes by physically detecting whether ice is present in the selected subset of ice making tubes (e.g., based on output from a temperature sensor that measures a temperature of one or more ice making tubes). The control unit also may infer whether ice remains in the selected subset of ice making tubes based on amount of water supplied to the selected ice making tubes during the dispensing operation or by detecting an amount of ice that has been dispensed during the dispensing operation.

In response to a determination that ice remains in the selected subset of ice making tubes, the control unit continues to provide ice using the selected subset of ice making tubes. For instance, the ice making process 1400 returns to reference numeral 1415.

In response to a determination that ice is absent from the selected subset of ice making tubes, the control selects another subset of ice making tubes to use in satisfying the actuation of the ice dispenser by the user (1435). The control unit may use techniques similar to those discussed above with respect to reference numeral 1410 to select another subset of ice making tubes.

The control units also makes ice in the previously selected subset of ice making tubes (1440). For example, the control unit controls components of the ice making device to make ice in the previously selected subset of ice making tubes. In this example, the control unit controls the one or more water supply valves corresponding to the previously selected subset of ice making tubes to open, controls the water supply pump to supply water to the previously selected subset of ice making tubes, and controls other components of the ice making device to freeze the supplied water into ice.

The control unit further provides ice using the newly selected subset of ice making tubes (1445). The control unit may use techniques similar to those discussed above with respect to reference numeral 1415 to provide ice using the newly selected subset of ice making tubes.

The control unit determines whether the dispensing operation is complete (1450). The control unit may use techniques similar to those discussed above with respect to reference numeral 1420 to determine whether the dispensing operation is complete.

In response to a determination that the dispensing operation is complete, the control unit ends the dispensing operation (1455). For example, the control unit closes water supply valves for the ice making tubes and controls components of the ice making device to freeze liquid water remaining in the ice making tubes (e.g., the liquid water used to partially release ice from the ice making tubes during the dispensing operation) into ice.

In response to a determination that the dispensing operation is not complete (e.g., ice dispensing continues), the control unit determines whether ice remains in the newly selected subset of ice making tubes (1460). The control unit may use techniques similar to those discussed above with respect to reference numeral 1430 to determine whether ice remains in the newly selected subset of ice making tubes.

In response to a determination that ice remains in the newly selected subset of ice making tubes, the control unit continues to provide ice using the newly selected subset of ice making tubes. For instance, the ice making process 1400 returns to reference numeral 1445.

In response to a determination that ice is absent from the newly selected subset of ice making tubes, the control unit determines whether ice is present in any of the ice making tubes (1465). For instance, the control unit may detect physical attributes of the ice making tubes to determine whether ice is present (e.g., by using a temperature sensor). The control unit also may compare a freezing time after finishing a last dispensing operation for one or more ice making tubes and infer whether ice is present in the one or more ice making tubes based on the freezing time and a time that it typically takes water held by an ice making tube to freeze into ice.

In response to a determination that ice is present in one or more of the ice making tubes, the control unit selects a subset of ice making tubes to use in satisfying the actuation of the ice dispenser by the user. This selected subset is from among the one or more of the ice making tubes in which ice is present, may be the previously selected subset (e.g., ice was made in the previously selected subset while the newly selected subset was used to provide ice), and may be a different subset of the ice making tubes. For instance, the ice making process 1400 returns to reference numeral 1410.

In response to a determination that ice is absent from all of the ice making tubes, the control unit provides an alert to user and waits until ice making completes (1470). For instance, the control unit provides output to inform the user that the dispenser is unable to perform ice dispensing because of a lack of made ice. The output also may include an estimated time (e.g., an amount of time) by which ice will be made and the dispenser will be operational to dispense ice. The output may be visual output provided on a display (e.g., an liquid crystal display (LCD) screen) and/or audible output provided by a speaker. The control unit may determine when ice has been made and is ready for dispensing and provide additional output to inform the user that the ice dispenser is ready to dispense ice.

In some examples, because water is supplied to the plurality of relatively long ice making tubes to make ice and ice of the ice making tubes is separated by using water pressure, the size of the ice making device may be reduced and the area taken up by the ice making device can be reduced. This may result in making the refrigerator having the ice making device thinner.

Also, because the ice making device allows ice separation from the upper side, the installation height of the ice making device can be lowered. Accordingly, the supply path of cool air can be shortened to prevent a loss of cool air when cool air is supplied to the ice making chamber.

In addition, because ice separation of the ice making device is performed by using the water supply unit, the configuration and operation controlling of the ice making device can be simplified. Accordingly, the fabrication cost can be reduced and a defect possibly caused by malfunction can be reduced in advance.

The ice making device, the refrigerator having the ice making device, and the ice making method of the refrigerator described throughout can be applicable to any freezing device having a refrigerator ice making device. It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. An ice making device comprising:
one or more ice making structures that each define an ice making space configured to receive and hold liquid water; and
a water supply unit connected to the ice making space of at least one of the ice making structures, the water supply unit being configured to:
supply a first amount of liquid water to the ice making space of the at least one of the ice making structures to which the water supply unit is connected, the first amount of liquid water being received in the ice making space and being frozen into ice; and
subsequent to the first amount of liquid water being received in the ice making space and being frozen into ice, supply a second amount of liquid water to the ice making space of the at least one of the ice making structures to which the water supply unit is connected, the second amount of liquid water being less than the first amount of liquid water and applying force to the ice made in the ice making space to partially release the ice from the ice making space.

2. The ice making device of claim 1, wherein the ice making device further comprises a heater configured to apply heat to an inner surface of the at least one of the ice making structures to facilitate release of the ice from the ice making space.

3. An ice making device comprising
an ice making structure that defines an ice making space configured to receive and hold liquid water;
a water supply unit configured to supply liquid water to the ice making space defined by the ice making structure; and
a control unit configured to control an amount of water supplied to the ice making structure by the water supply unit, the control unit being configured to, in response to user actuation of an ice dispenser, control the water supply unit to supply liquid water to the ice making space of the ice making structure to apply force to ice made in the ice making space and at least partially release the ice from the ice making space.

4. The ice making device of claim 3, wherein the ice making structure is an ice making tube that has a length that is larger than a diameter of the ice making tube, has a first end that is open and configured to allow ice to be released from the ice making tube, and has a second end that is hermetically connected with the water supply unit and that is configured to receive liquid water from the water supply unit.

5. The ice making device of claim 4, further comprising a cutter that is positioned at the first end of the ice making tube and that is configured to cut ice made in the ice making tube into one or more ice pieces when the ice made in the ice making tube is partially released from the ice making space by the supply of liquid water.

6. The ice making device of claim 5, further comprising a transfer tube that is configured to guide ice pieces cut by the cutter and that is positioned at the first end of the ice making tube,
wherein the cutter is positioned within the transfer tube.

7. The ice making device of claim 6, wherein the cutter is configured to rotate in a direction that is perpendicular to an ice transfer direction of ice pieces being guided in the transfer tube.

8. The ice making device of claim 6, wherein the ice making device includes multiple ice making tubes, the cutter includes multiple cutters, a first of the multiple cutters is positioned at a first side of the transfer tube, a second of the multiple cutters is positioned at a second side of the transfer tube that is opposite of the first side, and at least a portion of ice made by the multiple ice making tubes is positioned between the first and second cutters.

9. The ice making device of claim 6, wherein the cutter has blades that are screw shaped and that are wound in one or more directions.

10. The ice making device of claim 5, wherein the ice making device includes multiple ice making tubes, the multiple ice making tubes are oriented in parallel in a lengthwise direction, the multiple ice making tubes are connected to a single transfer tube, and a single cutter is installed within the single transfer tube.

11. The ice making device of claim 5, wherein a tube cover is positioned at the first end of the ice making tube and is configured to open and close the first end of the ice making tube.

12. The ice making device of claim 3, further comprising a heater configured to apply heat to the ice making structure to facilitate release of the ice from the ice making space.

13. The ice making device of claim 12, wherein the heater contacts the ice making structure.

14. The ice making device of claim 12, wherein the heater is spaced apart from the ice making structure.

15. The ice making device of claim 12, wherein the heater comprises a plurality of heaters that are each independently controlled and that are each positioned at a different portion of the ice making structure.

16. The ice making device of claim 15, wherein the plurality of heaters comprise a first heater and a second heater, the ice making space of the ice making structure receives liquid water from the water supply unit at an entry point, the first heater is positioned at a first portion of the ice making structure, the second heater is positioned at a second portion of the ice making structure that is further from the entry point than the first portion of the ice making structure, and, during an ice release operation, the first heater is controlled to apply heat to the first portion of the ice making structure prior to the second heater being controlled to apply heat to the second portion of the ice making structure.

17. The ice making device of claim 16, wherein the ice making structure is an ice making tube that has different diameters along a lengthwise direction, and a first diameter of the first portion where the first heater is positioned is smaller than a second diameter of the second portion where the second heater is positioned.

18. The ice making device of claim 12, wherein the control unit is configured to control the heater in conjunction with the water supply unit such that the control unit controls the heater to correspond to the supply, by the water supply unit, of liquid water to the ice making space of the ice making structure to apply force to the ice made in the ice making space and at least partially release the ice from the ice making space.

19. The ice making device of claim 18, wherein the control unit controls the heater based on an amount of water supplied by the water supply unit.

20. The ice making device of claim 18, wherein the control unit controls the heater according to a change in temperature of the ice making structure.

21. The ice making device of claim 3, further comprising a water supply valve configured to control flow of liquid water from the water supply unit to the ice making structure,
wherein the control unit is configured to control the water supply valve based on at least one of a water supply time duration and an amount of water supply.

22. A refrigerator comprising:
a refrigerator body;
a refrigerating compartment defined by the refrigerator body;
a freezing compartment defined by the refrigerator body and separated from the refrigerating compartment by one or more walls;
an ice making compartment positioned at a refrigerating compartment region of the refrigerator body and configured to receive cool air from the freezing compartment;
an ice dispenser configured to dispense ice; and
an ice making device comprising:
an ice making structure that defines an ice making space configured to receive and hold liquid water, the ice making structure being positioned in the ice making compartment;
a water supply unit configured to supply liquid water to the ice making space defined by the ice making structure; and
a control unit configured to control an amount of water supplied to the ice making structure by the water supply unit, the control unit being configured to, in response to user actuation of the ice dispenser, control the water supply unit to supply liquid water to the ice making space of the ice making structure to apply force to ice made in the ice making space and at least partially release the ice from the ice making space.

23. The refrigerator of claim 22, further comprising a refrigerator door coupled to the refrigerator body and configured to open and close at least a portion of the refrigerating compartment,
wherein the ice dispenser is positioned on an external surface of the refrigerator door and configured to dispense ice made by the ice making device through the refrigerator door, and
wherein the ice making compartment is positioned on an internal surface of the refrigerator door that is opposite of the external surface and positioned such that at least a portion of the ice compartment overlaps with the dispenser.

24. The refrigerator of claim 22, wherein the ice making structure includes a plurality of ice making tubes arranged in a single row.

25. The refrigerator of claim 22, wherein the ice making structure includes a plurality of ice making tubes arranged in multiple rows.

26. An ice making method of an ice making device, the method comprising:
supplying a first amount of liquid water to an ice making structure configured to receive and hold liquid water;
freezing the first amount of liquid water supplied to the ice making structure into ice stored in the ice making structure; and
subsequent to the first amount of liquid water being supplied to the ice making structure and being frozen into ice, partially releasing the ice stored in the ice making structure by supplying a second amount of liquid water to the ice making structure to apply force to the ice stored in the ice making structure, the second amount of liquid water being less than the first amount of liquid water.

27. The method of claim 26, wherein supplying the first amount of liquid water to the ice making structure configured to receive and hold liquid water comprises detecting a value based on at least one of a time period during which water is supplied to the ice making structure and an amount of water supplied to the ice making structure, and determining whether or not the detected value has reached a pre-set value.

28. The method of claim 26, wherein freezing the first amount of liquid water supplied to the ice making structure into ice stored in the ice making structure comprises detecting a change in temperature of the ice making structure or detecting amount of time lapsed after supplying the first amount of water to the ice making structure, and determining whether or not the first amount of liquid water has been frozen into ice based on the detected change in temperature of the ice making structure or the detected amount of time lapsed after supplying the first amount of water to the ice making structure.

29. The method of claim 26, further comprising, prior to partially releasing the ice stored in the ice making structure by supplying the second amount of liquid water to the ice making structure, applying heat to the ice making structure to facilitate release of the ice from the ice making structure when the second amount of water is supplied.

30. The method of claim 29, further comprising, prior to partially releasing the ice stored in the ice making structure by supplying the second amount of liquid water to the ice making structure, stopping a supply of cool air to the ice making compartment.
